(19) United States
(12) Patent Application Publication
(10) Pub. No.: US 2003/0063208 A1
(43) Pub. Date: Apr. 3, 2003

(54) Image pick-up apparatus

(75) Inventor: Kazuyuki Kazami, Itabashi-ku (JP)

Correspondence Address: OLIFF & BERRIDGE, PLC, P.O. BOX 19928, ALEXANDRIA, VA, 22320, US

(73) Assignee: Nikon Corporation, Chiyoda-ku (JP)

(21) Appl. No.: 10/289,375

(22) Filed: Nov. 7, 2002

Related U.S. Application Data
(63) Continuation of application No. 09/842,253, filed on Apr. 26, 2001, now abandoned.
Application No. 09/842,253 is a continuation of application No. 08/873,183, filed on Jun. 11, 1997, now abandoned.

(30) Foreign Application Priority Data
Jun. 12, 1996 (JP) 8-150753
Nov. 29, 1996 (JP) 8-319886

(51) Int. Cl. H04N 5/222

(52) U.S. Cl. 348/333.13

(57) ABSTRACT

The image pickup apparatus of the present invention includes an image pickup device that captures an image of a subject so as to produce an image signal representing the subject, a display device on which a visible image is displayed by the image signal, an optical finder that allows the image of the subject to be observed therethrough, a detecting device that detects a user approaching the optical finder; and a control device that controls an operation of the display device, based on a result of detection of the detecting device.

### INCORPORATION BY REFERENCE

The disclosures of the following priority applications are herein incorporated by reference:

Japanese Patent Application No. 8-150753 filed Jun. 12, 1996

Japanese Patent Application No. 8-319886 filed Nov. 29, 1996.

### BACKGROUND OF THE INVENTION

1. Field of the Invention

The present invention relates to an image pickup apparatus, such as a digital still camera, which is provided with a monitor screen, such as a liquid crystal panel.

2. Description of the Related Art

A digital still camera having an electric viewfinder function is known wherein an image of a subject captured by the camera is displayed in real time on a monitor, such as a liquid crystal panel provided on a main body of the camera. In this type of camera, the image of the subject to be captured may be observed on the monitor while the user's eyes are spaced apart from an optical finder of the camera. Thus, the user is not required to look through the optical finder, and can easily operate the camera to conduct an image pickup operation.

In the camera having such a monitor, however, an illuminating device for illuminating a transparent-type liquid crystal panel and a liquid crystal panel is generally needed for displaying the subject image on the monitor, and a large amount of electric power is required to operate this illuminating device. Accordingly, the battery of the camera tends to be rapidly consumed, resulting in a possibility of missing the opportunity to release the shutter to catch a desired image due to running out of the battery power during the image pickup operation.

Also, the camera having such a monitor may be equipped with an input device (such as a so-called touch tablet through which line drawing information can be entered) that is operated by touching, for example, to enter desired information, such that the input device is superposed on the screen of the monitor. In this case, the user comes very close to the camera when he/she observes the subject through the optical finder, which may cause a problem that the input device may be operated by mistake due to its contact with the nose of the user, for example.

### SUMMARY OF THE INVENTION

It is therefore an object of the present invention to provide an image pickup apparatus which is able to reduce consumption of the battery, and is also able to avoid wrong operations.

To accomplish the above object, an image pickup apparatus according to the present invention comprises an image pickup device that captures an image of a subject so as to produce an image signal representing the subject, a display device on which a visible image is displayed by the image signal, an optical finder that allows the image of the subject to be observed therethrough, a detecting device that detects a user approaching the optical finder; and a control device that controls an operation of the display device, based on a result of detection of the detecting device.

An image pickup apparatus according to another aspect of the present invention comprises an optical finder that allows an image of a subject to be observed therethrough, a detecting device that detects a user approaching the optical finder, an information input device that is operated to enter information, a processing device that processes the information entered through the information input device, and a control device that controls the processing device to stop processing of the information entered through the information input device, when the detecting device detects the user approaching the optical finder.

### BRIEF DESCRIPTION OF THE DRAWINGS

FIG. 1 is a perspective view showing the construction of an electronic camera 1 of the first embodiment of the present invention when viewed from the front side thereof.

FIG. 2 is a perspective view showing the construction of the electronic camera shown in FIG. 1 when viewed from the rear side thereof.

FIG. 3 is a perspective view showing the construction of the inside of the electronic camera 1 shown in FIG. 1 and FIG. 2.

FIG. 4 is a cross sectional view showing an example of the location of a light-receiving element 43;

FIG. 5 is a view explaining the manner in which the light-receiving element 43 detects the user approaching the finder;

FIG. 6 is a block diagram showing an electric arrangement in the inside of the electronic camera shown in FIG. 1 and FIG. 2.

FIG. 7 is a view explaining processing for thinning out pixels in “L” mode.

FIG. 8 is a view explaining processing for thinning out pixels in “H” mode.

FIG. 9 is a view showing an example of a display screen of the electronic camera 1 shown in FIG. 1 and FIG. 2.

FIG. 10 is a view showing the second embodiment of the present invention.

FIG. 11 is a cross sectional view showing an example of the locations of LED 61 and light-receiving element 62 in the electronic camera of FIG. 10.

FIG. 12 is a view explaining the manner of detecting the user 101 approaching the finder in the electronic camera of FIG. 10.

FIG. 13 is a view explaining the schematic construction of an image pickup apparatus according to the third embodiment of the present invention.

FIG. 14 is a perspective view showing the construction of a digital still camera as an example of the image pickup apparatus according to the third embodiment of the present invention.

FIG. 15 is a block diagram showing the system structure of the camera shown in FIG. 14.

FIG. 16 is a flow chart explaining the operation of the third embodiment.

FIG. 17 is a flow chart explaining the operation of the fourth embodiment.

FIG. 18 is a flow chart explaining the operation of the fifth embodiment.

FIG. 19 is a flow chart explaining the operation of the sixth embodiment.

FIG. 20 is a flow chart explaining the operation of the seventh embodiment.

FIG. 21 is a perspective view showing the construction of a digital still camera as one example of the image pickup device according to the eighth embodiment of the present invention.

FIG. 22 is a view explaining the schematic construction of the image pickup apparatus according to the eighth embodiment of the present invention.

FIG. 23 is a block diagram showing the system structure of the camera according to the eighth embodiment.

FIG. 24 is a flow chart explaining the operation of the eighth embodiment.

FIG. 25 is a flow chart explaining the operation of the ninth embodiment.

FIG. 26 is a block diagram showing an electric arrangement in the inside of the electronic camera 1 provided with a temperature sensor.

FIG. 27 is a view showing a modified example of the sensor of the second embodiment.

FIG. 28 is a view showing another modified example of the sensor of the second embodiment.

FIG. 29 is a view showing a further modified example of the sensor of the second embodiment.

### DESCRIPTION OF THE PREFERRED EMBODIMENT(S)

First Embodiment

The first embodiment of the present invention will be described referring to the drawings.

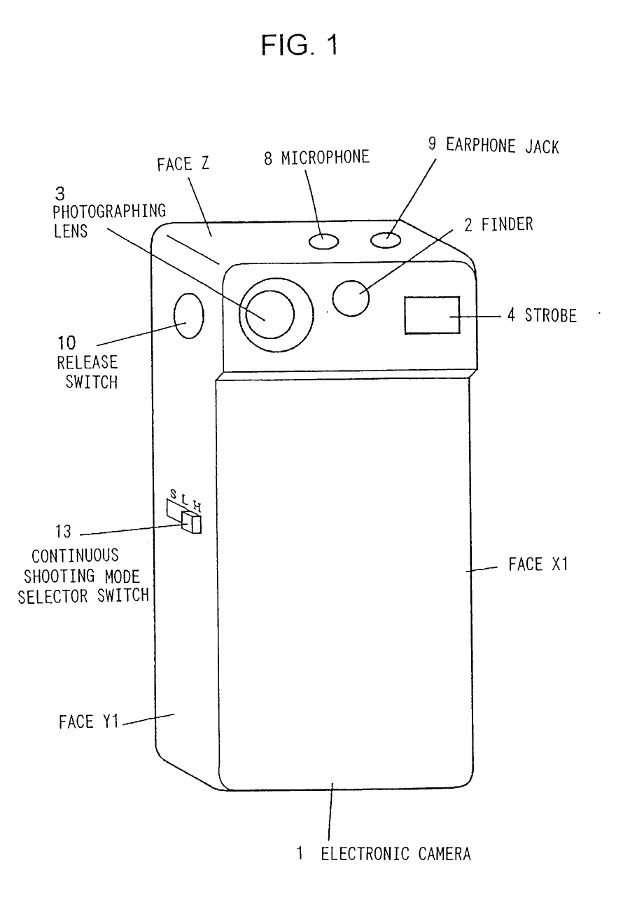

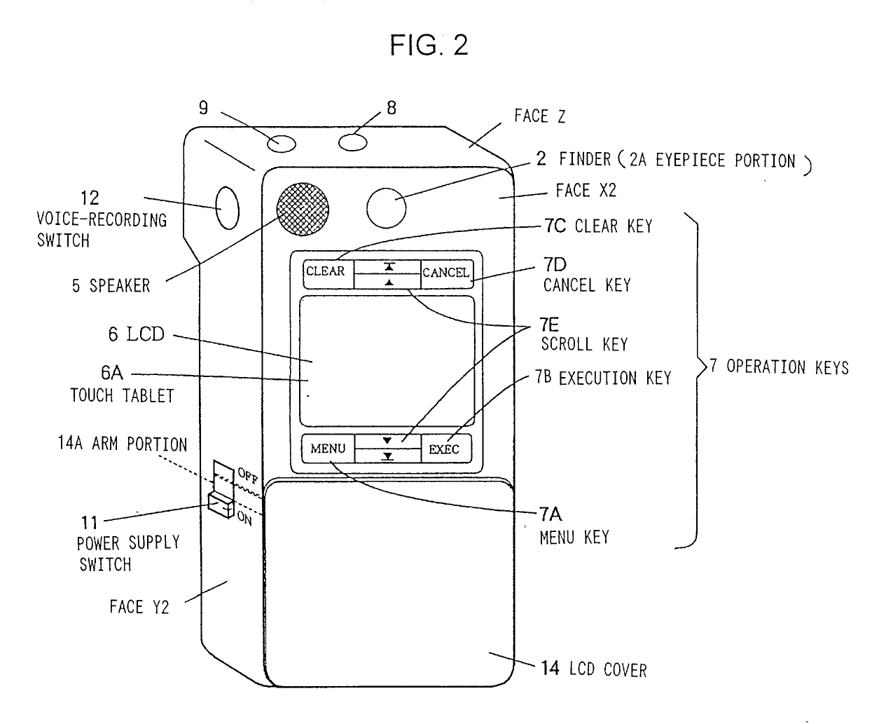

FIG. 1 and FIG. 2 are perspective views showing the construction of the first embodiment of the present invention. The electronic camera of the first embodiment has a face X1 that is directed toward a subject and a face X2 that is directed toward a photographer when the subject is photographed. A finder (presenting means) 2 used for confirming a photographing range of the subject, photographing lens 3 (converging means) through which an optical image of the subject enters the camera, and a strobe 4 that emits light for illuminating the subject. The above finder 2 is called an optical viewfinder, in contrast with an electronic view finder.

On the other hand, the finder 2 as described above, and a speaker 5 that outputs voice recorded in this electronic camera 1 are provided in the upper end portion of the face X2 (corresponding to the upper end portion of the face Xl in which are formed the finder 2, photographing lens 3, and strobe 4) that is opposite with the face X1. Further, an LCD 6 (display means) and operating keys 7 are formed in the face X2, at a lower position than those of the finder 2, photographing lens 3, strobe 4 and speaker 5 in the vertical direction. A so-called touch tablet 6A (information input means) is disposed on the surface of the LCD 6, in parallel with an eyepiece portion 2A of the finder 2. This touch tablet 6A is adapted to output position data corresponding to a designated position at which a pen-type pointing member contacts with the tablet 6A.

This touch tablet (also called “touch panel”) 6A is formed of a transparent material, such as glass or resin, and a user (photographer) can observe an image displayed on the LCD formed inside the touch tablet 6A, through the touch tablet 6A.

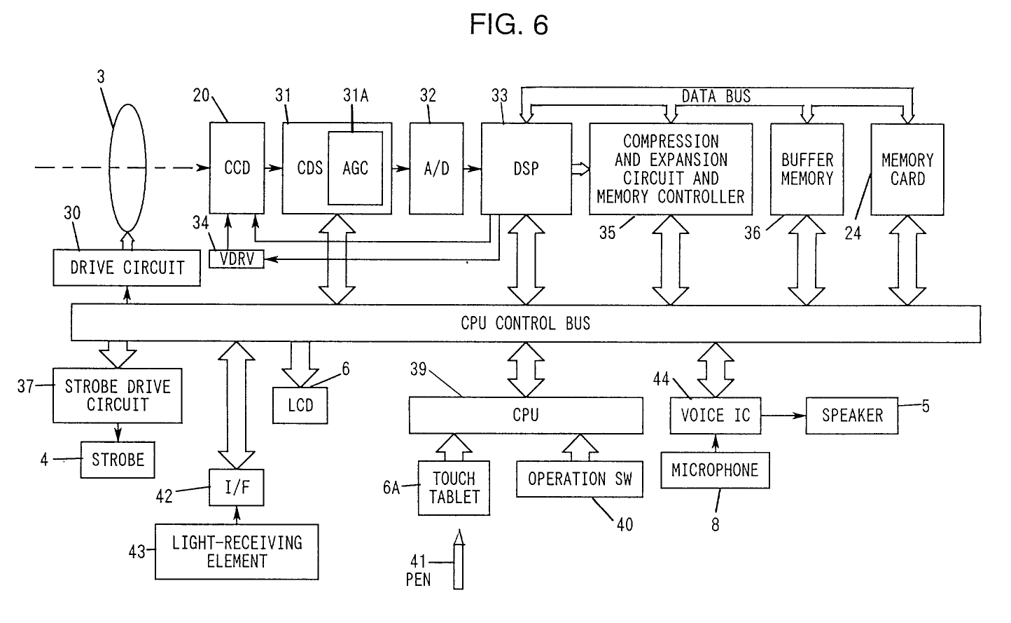

The operation keys 7 are operated when recorded data are reproduced or displayed on the LCD 6. The operation keys 7 are printed on the face X2, and parts of the touch tablet 6A are used to detect any one of the keys 7 that is being operated by the user, so that a signal corresponding to this operation is transmitted to CPU 39 (FIG. 6) (control means, processing means).

The operation keys 7 include a MENU key 7A that is operated when a menu screen is to be displayed on the LCD 6, and an EXEC (execution) key 7B that is operated when recorded information selected by the user is to be reproduced.

CLEAR key 7C is operated so as to delete recorded information, and CANCEL key 7D is operated so as to interrupt processing for reproducing the recorded information. Scroll keys 7E are operated so as to scroll the screen in the vertical direction while a list of recorded information is displayed on the LCD 6.

A slidable LCD cover 14 is provided on the face X2, for protecting the LCD 6 when it is not in use. The LCD cover 14 may be moved upward in the vertical direction so as to cover the LCD 6 and touch tablet 6A. If the LCD cover 14 is then moved downward in the vertical direction, the LCD 6 and touch tablet 6A will appear, and at the same time a power supply switch 11 provided in the side face Y2 will be switched to the ON-state by an arm portion 14A of the LCD cover 14.

The electronic camera is provided at its upper face Z with a microphone 8 for collecting voice, and an earphone jack 9 to which an earphone that is not illustrated is connected.

On the left side face (Y1) are provided a release switch 10 that is operated when a subject is photographed, and a continuous shooting mode selector switch 13 that is operated when one of photographing modes is switched to another when a picture or pictures is/are taken. The release switch 10 and continuous shooting mode selector switch 13 are located at lower positions in the vertical direction than the finder 2, photographing lens 3 and strobe 4 provided in the upper end portion of the face X1.

On the other hand, a recording switch 12 that is operated when voice is recorded, and the power supply switch 11 are provided on the face Y2 (right side face) opposite with the face Y1. Like the release switch 10 and continuous shooting mode selector switch 13 as described above, the recording switch 12 and power supply switch 11 are located at lower positions in the vertical direction than the finder 2, photographing lens 3 and strobe 4. The recording switch 12 is formed at substantially the same height as the release switch 10 on the face Y1, so that the user will not get a sense of incompatibility no matter which of his/her right and left hands holds the camera.

It is to be understood that the recording switch 12 and the release switch 10 may be provided at different heights. In this arrangement, when one of the switches is pressed while the side face opposite with this switch is held by fingers to cancel the moment caused by the pressing force, the other switch provided on the opposite side face can be prevented from being pressed by mistake.

The continuous shooting mode selector switch 13 is used for selecting whether only one picture of a subject is taken or a certain plural number of pictures are taken, when the subject is photographed with the release switch 10 pressed by the photographer. When a pointer of the continuous shooting mode selector switch 13 is placed in a position at which the letter “S” is printed (namely, when the switch 13 is placed in “S” mode), only one picture is taken when the release switch 10 is pressed.

When the release switch 10 is pressed while the pointer of the continuous shooting mode selector switch 13 is placed in a position at which the letter “L” is printed (namely, when the switch 13 is placed in “L” mode), pictures are taken at the rate of 8 frames per second during the time period in which the release switch 10 is pressed (namely, a low-speed continuous shooting mode is established).

When the release switch 10 is pressed while the pointer of the continuous shooting mode selector switch 13 is placed in a position at which the letter “H” is printed (namely, when the switch 13 is placed in “H” mode), pictures are taken at the rate of 30 frames per second during the time period in which the release switch 10 is pressed (namely, a high-speed continuous shooting mode is established).

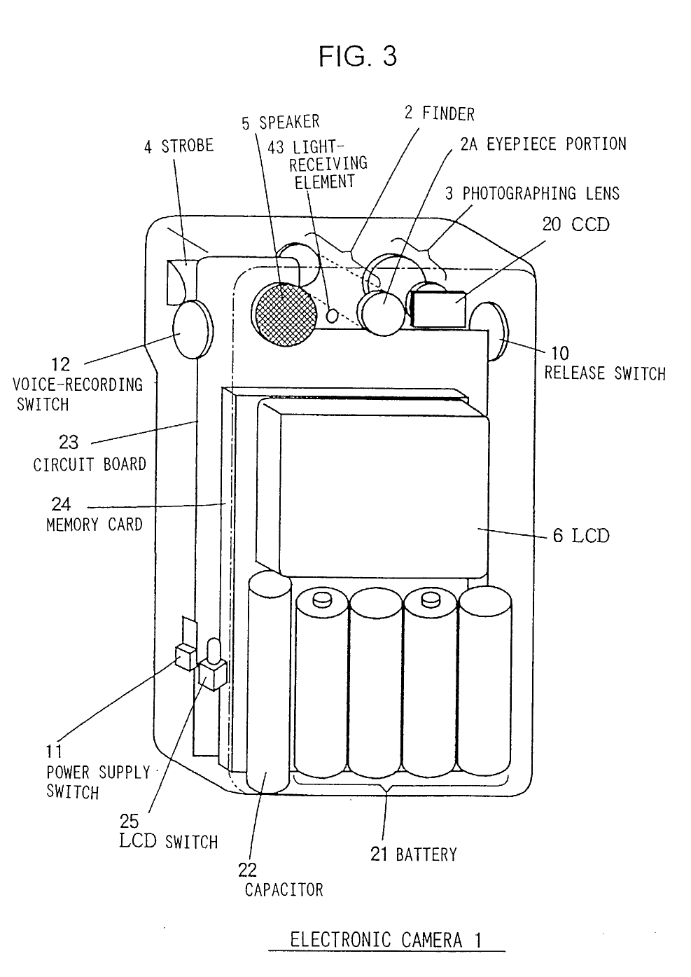

The construction of the interior of the electronic camera 11 will be now explained. FIG. 3 is a perspective view showing an example of the inner construction of the electronic camera shown in FIG. 1 and FIG. 2. CCD 20 (photoelectric converting means) is provided on the rear side (on the side of the face X2) of the photographing lens 3, and serves to photoelectrically convert an optical image of a subject focused thereon through the photographing lens 3, into electric signals.

Light-receiving element (photosensor) 43 (detecting means) is disposed adjacent to the finder 2, and is adapted to receive light that is incident through the eyepiece portion 2A of the finder 2.

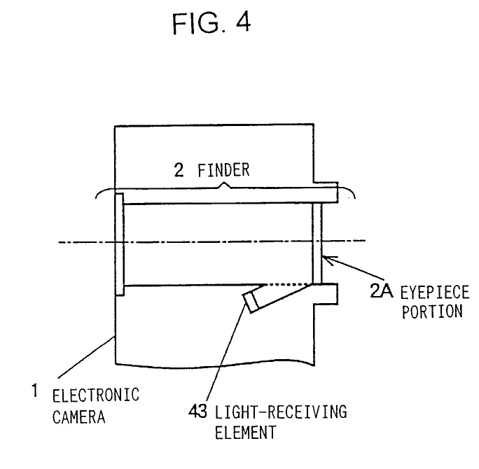

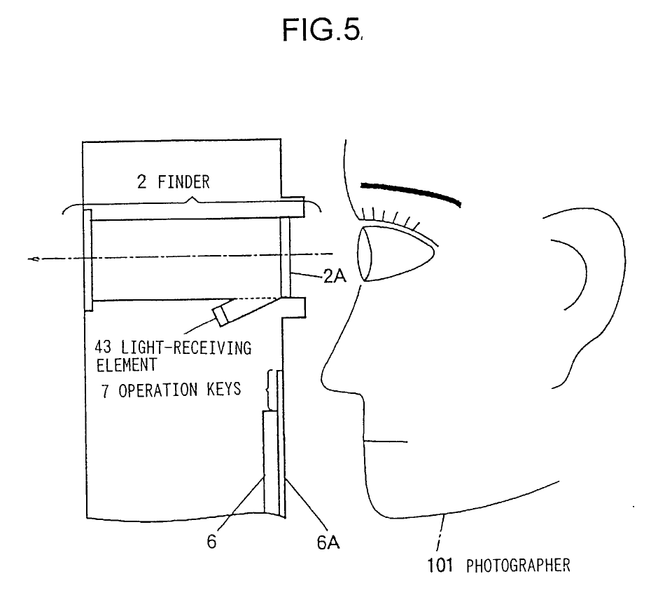

FIG. 4 shows an example of the location of the light-receiving element 43. As shown in this example, the light-receiving element 43 is located so as not to become an obstacle when the photographer observes or recognizes the subject by viewing it through the finder 2. This light-receiving element 43 receives light introduced from the eyepiece portion 2A, and transmits an electric signal representing the quantity of the light to the CPU 39 (FIG. 6), through an interface (I/F) 42 (FIG. 6). Since the quantity of light incident upon the light-receiving element 43 is reduced when the photographer 101 approaches the eyepiece portion 2A as shown in FIG. 5, the CPU 39 determines that the photographer 101 is approaching the eyepiece portion 2A of the electronic camera 1, based on a change in the electric signal received from the light-receiving element 43.

Referring back to FIG. 3, four column-like batteries (size AA batteries) 21 are arranged in parallel vertically on the lower side of the LCD 6 to extend in the vertical direction, and electric power stored in the batteries 21 is fed to various portions of the camera. In addition, a capacitor 22 that stores electric charges for causing the strobe 4 to emit light is disposed along with the batteries 21 on the lower side of the LCD 6.

Various control circuits for controlling respective portions of the electronic camera 1 are formed on a circuit board 23. A memory card 24 is provided in a space between the circuit board 23, and the LCD 6 and batteries 21, such that the memory card 24 may be inserted into and removed from the space. Various kinds of information entered into this electronic camera 1 are respectively recorded in predetermined regions of the memory card 24.

An LCD switch 25 disposed adjacent to the power supply switch 11 is placed in an ON state only during the time when its protrusion is depressed. When the LCD cover 14 is moved downward in the vertical direction, the LCD switch 25 as well as the power supply switch 11 is switched to the ON state by the arm portion 14A of the LCD cover 14.

Where the LCD cover 14 is placed in the upper position, the power supply switch 11 is operated by the user, independently of the LCD switch 25. The electric power is fed to the LCD 6 when the power supply switch 11 and LCD switch 25 are both placed in the ON state, and the LCD 6 is turned off when the LCD switch 25 is in the OFF state (namely, when the LCD cover 14 is closed) (in this state, the power is fed to the other circuits if the power supply switch 11 is placed in the ON state).

While the memory card 24 may be inserted into and removed from the above-described space in the first embodiment, a memory may be provided on the circuit board 23 such that various kinds of information can be recorded in this memory. The various kinds of information recorded in the memory (memory card 24) may be generated to an external personal computer, through an interface that is not illustrated.

Referring next to the block diagram of FIG. 6, an electric arrangement in the inside of the electronic camera 1 of the first embodiment will be explained. The CCD 20 having a plurality of pixels is adapted to photoelectrically convert an optical image focused on each of the pixels into an image signal (electric signal). A digital signal processor (hereinafter referred to as “DSP”) 33 supplies the CCD 20 with CCD horizontal drive pulses, and also controls a CCD drive circuit (VDRV) 34 so as to supply the CCD 20 with CCD vertical drive pulses.

Correlation double sampling circuit (hereinafter referred to as “CDS”) 31 is controlled by the CPU 39 so as to sample in suitable timing the image signals into which the optical image is photoelectrically converted by the CCD 20. The signals thus sampled are amplified to a certain level by an automatic gain controller (hereinafter referred to as “AGC”) incorporated in the CDS 31. Analog/digital converting circuit (hereinafter referred to as A/D converting circuit) 32 converts the image signals sampled by the CDS 31 into equivalent digital signals, which are then transmitted to the DSP 33.

Compression and expansion circuit and memory controller 35 controls a data bus that connects the DSP 33, buffer memory 36 and memory card 24 with each other, so that the image signals transmitted to the DSP 33 are once stored in a data region (which will be described later) of the buffer memory 36. This controller 35 then retrieves or reads out the image data stored in the data region of the buffer memory 36, and compresses the image data so that the image data subjected to the compression processing (hereinafter simply referred to as photographic image data) are recorded in a certain region (photographic image recording region) of the memory card 24.

The buffer memory 36 is divided into a data region and a frame memory region. The data region of the buffer memory 36 is used not only for temporarily retaining data that are being processed, but also for reducing a difference between the input/output speed of data to and from the memory card 24, and the processing speed of the CPU 39 and DSP 33, for example. The frame memory region of the buffer memory 36 is used as a frame memory that retains values of respective pixels of the LCD 6.

The compression and expansion circuit and memory controller 35 causes the buffer memory 36 to store the image data transmitted to the DSP 33 in its frame memory region, and causes the LCD 6 as an electronic viewfinder to display an image represented by the image data. This controller 35 also retrieves photographic image data from the memory card 24, expands the photographic image data, and then causes the buffer memory 36 to store the expanded image data in its frame memory region, so that an image represented by the image data is displayed on the LCD 6.

In addition, the compression and expansion circuit and memory controller 35 controls the timing of input and output of data, such as when data are recorded into the memory card 24, or when the expanded image data are stored into the buffer memory 36.

The compression and expansion circuit and memory controller 35 incorporates a clock circuit that is not illustrated, and is adapted to record information relating to the date and time of photographing in the photographic image recording region of the memory card 24, as header information of image data. (Namely, the photographic image data recorded in the photographic image recording region of the memory card 24 are accompanies by data relating to the date and time of photographing.)

The microphone 8 receives voice information (or collects voice), and transmits the voice information to a voice processing circuit (voice IC) 44. The voice processing circuit 44 digitizes the voice information transmitted thereto, and generates the digitized information to the CPU 39.

After the digitized voice information is compressed by the CPU 39, the digitized and compressed voice data are once stored in the buffer memory 36 (data region), and then recorded in a certain region (voice recording region) of the memory card 24. At the same time, data relating to the date and time of voice-recording are also stored as header information of the voice data in the voice recording region of the memory card 24.

The voice processing circuit 44 converts the voice data received from the CPU 39 into analog signals, and drives the speaker 5 to output the analog voice signals.

When a certain position of the touch tablet 6A is pressed by a pen (pen-type pointing member) 4 operated by the user, the CPU 39 reads X-Y coordinates of the pressed position of the touch tablet 6A, and coordinate data (line drawing information that will be described) representing the X-Y coordinates are stored in the data region of the buffer memory 36. The CPU 39 also records the line drawing information stored in the buffer memory 36, along with header information indicative of the date and time of input of the line drawing information, in a line drawing information recording region of the memory card 24.

Further, the CPU 39 controls a strobe drive circuit 37 so as to cause the strobe 4 to emit light when appropriate, and controls a drive circuit 30 so as to move the photographing lens 3, thereby to perform autofocus operations.

The CPU 39 receives signals from operating switches 40 including the power supply switch 11 and recording switch 12, and suitably processes the received signals.

The light-emitting element 43 receives light incident thereupon through the eyepiece portion 2A of the finder 2, and transmits an electric signal representing the quantity of the received light to the CPU 39. The CPU 39 detects a change in the electric signal from the light-receiving element 43, to determine whether the photographer 101 has approached the finder 2 of the electronic camera.

If the value of the electric signal corresponding to the quantity of the light incident upon the light-emitting element 43 remains smaller than a certain reference value for a predetermined time, the CPU 39 judges that the photographer 101 has approached the eyepiece portion 2A. When the quantity of the light incident upon the light-receiving element 43 is momentarily reduced due to noise, for example, the CPU 39 does not determine that the photographer 101 has approached the eyepiece portion 2A.

When it is determined that the photographer 101 has approached the finder 2 of the electronic camera 1, the CPU 39 stops displaying any image on the LCD 6, and also stops processing of input information entered through the touch tablet 6A.

Since the photographer 101 does not look at the image or other information displayed on the LCD 6 (electronic viewfinder) while he/she is using the finder 2 (optical finder), the CPU 39 stops displaying on the LCD 6, thereby to prevent waste of electric power. To stop displaying on the LCD 6, the power supply to both of liquid crystal and back light portions of the LCD 6 is stopped. Alternatively, the power supply may be stopped only with respect to the back light portion that normally consumes a large amount of electric power.

Further, the processing of the input information entered through the touch tablet 6A is stopped, so that a wrong operation can be avoided in case that the touch tablet 6A is touched by the nose of the photographer 101, for example.

Various operations of the electronic camera 1 of the first embodiment will be now described. In the first place, photographing of a subject using the present apparatus will be explained.

The case where the continuous shooting mode selector switch 13 provided on the face Y1 is placed in the “S” mode (in which only one picture is taken) will be first described. Initially, the power supply switch 11 shown in FIG. 1 is operated to the side where the letters “ON” are printed, so as to turn on the electronic camera 1. After a subject is recognized through the finder 2, the release switch 10 provided on the face Y1 is pressed so as to start processing for taking a picture of the subject.

An optical image of the subject observed through the finder 2 is converged by the photographing lens 3, and focused on the CCD 20 having a plurality of pixels. The optical image of the subject thus focused on the CCD 20 is photoelectrically converted into image signals in respective pixels, which signals are then subjected to sampling by the CDS 31. The image signals thus sampled by the CDS 31 are then transmitted to the A/D converting circuit 32, and digitized in this circuit and generated to the DSP 33.

The DSP 33 transmits the image data thus received to the data region of the buffer memory 36. The compression and expansion circuit and memory controller 35 retrieves the image data from the buffer memory 36, compresses the data according to JPEG (Joint Photographic Experts Group) method that is a combination of discrete cosine transform (DCT), quantization and Huffman coding, and then records the compressed data in the photographic image recording region of the memory card 24. At the same time, data indicative of the date and time of photographing is also recorded as header information of the photographic image data in the photographic image recording region of the memory card 24.

When the continuous shooting mode selector switch 13 is placed in the “S” mode, only one picture is taken, and no more pictures are taken even if the release switch 10 is kept being pressed. If the release switch 20 is kept being pressed in this. state, the photographed image is displayed on the LCD 6.

The second case where the continuous shooting mode selector switch 13 is placed in the “L” mode (in which pictures are continuously taken at the rate of 8 frames per second) will be now explained. Initially, the power supply switch 11 is operated to the side where the letters “ON” are printed, so as to turn on the electronic camera 1, and the release switch 10 provided on the face Y1 is then pressed so as to start processing for taking pictures of a subject.

An optical image of the subject observed through the finder 2 is converged by the photographing lens 3, and focused on the CCD 20 having a plurality of pixels. The optical image of the subject thus focused on the CCD 20 is photoelectrically converted into image signals in respective pixels, and the CDS 31 performs sampling of the image signals 8 times per second. At this time, the CDS 31 eliminates or erases three-quarters of pixels out of the image electric signals of all pixels of the CCD 20.

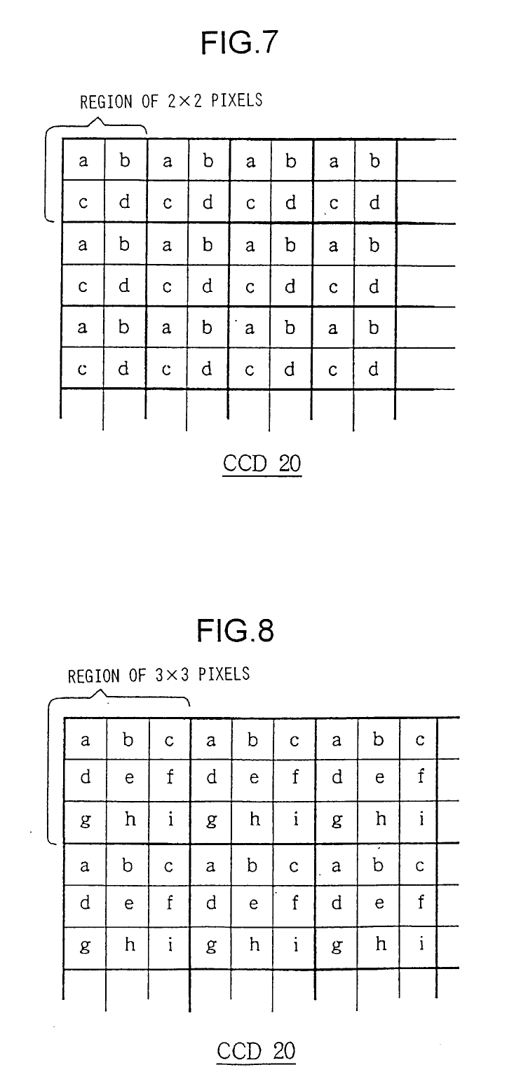

More specifically, the CDS 31 divides the pixels of the CCD 20 arranged in matrix form into a plurality of regions each having 2×2 pixels (four pixels), as shown in FIG. 7, and samples out or selects an image signal of one pixel located in a given position from one of the regions while eliminating the remaining three pixels.

For example, upon the first sampling (for the first frame), the left, upper pixel “a” in each region is sampled out, and the other pixels “b”, “c”, “d” are eliminated. Upon the second sampling (for the second frame), the right, upper pixel “b” in each region is sampled out, and the other pixels “a”, “c”, “d” are eliminated. Similarly, upon the third and fourth sampling, the left, lower pixel “c” and the right, lower pixel “d” are sampled out, respectively, and the other pixels are eliminated. Namely, all of the four pixels are sampled out each time four frames are processed.

The image signals thus sampled by the CDS 31 (image signals of one-quarter of all of the pixels of CCD 20) are then transmitted to the A/D converting circuit 32, and digitized in this circuit and generated to the DSP 33.

The DSP 33 transmits the digitized image signals to the data region of the buffer memory 36. The compression and expansion circuit and memory controller 35 retrieves the image signals from the buffer memory 36, compresses the signals according to the JPEG method, and then records the digitized and compressed photographic image data in the photographic image recording region of the memory card 24. At this time, data indicative of the date and time of photographing is recorded as header information of the photographic image data, in the photographic image recording region of the memory card 24.

The third case where the continuous shooting mode selector switch 13 is placed in the “H” mode (in which pictures are continuously taken at the rate of 30 frames per second) will be now explained. Initially, the power supply switch 11 is operated to the side where the letters “ON” are printed, so as to turn on the electronic camera 1, and the release switch 10 provided on the face Y1 is then pressed so as to start processing for taking pictures of a subject.

An optical image of the subject observed through the finder 2 is converged by the photographing lens 3, and focused on the CCD 20. The optical image of the subject thus focused on the CCD 20 having a plurality of pixels is photoelectrically converted into image signals in the respective pixels, and the CDS 31 performs sampling of the image signals 30 times per second. At this time, the CDS 31 eliminates or erases eight-ninths of pixels out of the image electric signals of all pixels of the CCD 20.

More specifically, the CDS 31 divides the pixels of the CCD 20 arranged in matrix form into a plurality of regions each having 3×3 pixels, as shown in FIG. 8, and samples out an image signal of one pixel located in a give position from one of the regions at the rate of 30 times per second, while eliminating the remaining eight pixels.

For example, upon the first sampling (for the first frame), the left, upper pixel “a” in each region is sampled out, and the other pixels “b” through “d” are eliminated. Upon the second sampling (for the second frame), the pixel “b” located to the right of the pixel “a” is sampled out, and the other pixels “a”, “c” through “d” are eliminated. Similarly, upon the third and following sampling, the pixels “c”, “d”, are sampled out, respectively, and the other pixels are eliminated. Namely, all of the nine pixels are sampled out each time nine frames are processed.

The image signals thus sampled by the CDS 31 (image signals of one-ninth of all of the pixels of CCD 20) are then transmitted to the A/D converting circuit 32, and digitized in this circuit and generated to the DSP 33.

The DSP 33 transmits the digitized image signals to the data region of the buffer memory 36. The compression and expansion circuit and memory controller 35 retrieves the image signals from the buffer memory 36, compresses the signals according to the JPEG method, and then records the digitized and compressed photographic image data in the photographic image recording region of the memory card 24, along with the header information relating to the date and time of photographing.

Moreover, the strobe 4 may be operated so as to illuminate the subject as the need arises.

Next, the operation of entering two-dimensional information (pen input information) through the touch tablet 6A will be described.

When the touch tablet 6A is pressed by the tip of the pen 41, the X-Y coordinates of the position of the tablet 6A contacting with the pen 41 are entered into the CPU 39. The X-Y coordinates are stored in the data region of the buffer memory 36. Also, data are written into a portion of the frame memory region of the buffer memory 36 that corresponds to each point of the above X-Y coordinates, so that a line drawing formed by contact of the pen 41 may be displayed in the position of the above X-Y coordinates on the LCD 6.

Since the touch tablet 6A is formed from a transparent member as described above, the user can observe a point (located at a position pressed by the tip of the pen 41) that is displayed on the LCD 6, and feel as if the point were directly drawn with the pen on the LCD 6. If the pen 41 is moved on the touch tablet 6A, a line that follows the movement of the pen 41 is displayed on the LCD 6. Further, if the pen 41 is intermittently moved on the touch tablet 6A, a broken line that follows the movement of the pen 41 is displayed on the LCD 6. In this manner, the user enters desired line drawing information, such as letters or drawings, into the touch tablet 6A (LCD 6).

If line drawing information is entered by use of the pen 41 while a photographic image is displayed on the LCD 6, the line drawing information is combined with the photographic image information in the frame memory region of the buffer memory 36, and the combined information is concurrently displayed on the LCD 6.

The user may select the color of the line drawing displayed on the LCD from such colors as black, white, red and blue, by operating a color selecting switch that is not illustrated.

If the execution (EXEC) key 7B of the operating keys 7 is pressed after the line drawing information is entered with the pen 41 through the touch tablet 6A, the line drawing information stored in the data region of the buffer memory 36 is transmitted to the memory card 24, along with the header information related to the date and time of entering, and recorded in a line drawing information recording region of the memory card 24.

The line drawing information recorded in the memory card 24 is subjected to compression processing. In this connection, the line drawing information entered through the touch tablet 6A includes a lot of information having high spatial frequency components. If such information is compressed by the above-described JPEG method used for compressing the photographic image, the compression efficiency is deteriorated, and the volume of information cannot be sufficiently reduced, whereby the time required for compression and expansion is prolonged. Further, the compression according to the JPEG method, which is non-reversible compression, is not suited for compression of line drawing information having a relatively small amount of information. (When the information is expanded and displayed on the LCD 6, gathers or bleeding may appear due to lack of a part of the information.)

In the first embodiment, therefore, the line drawing information is compressed by a run-length coding method used in facsimile machines, for example. In the run-length coding method, the line drawing information is compressed by scanning a screen with the line drawing in horizontal directions, and coding the length over which information (point) of each color, such as black, white, red, or blue, continues, and the length over which no information (no input by the pen) continues.

The use of the run-length coding method makes it possible to compress the line drawing information to the minimum, and prevent lack of the information when the compressed line drawing information is expanded. The line drawing information may not be compressed where the volume of the information is relatively small.

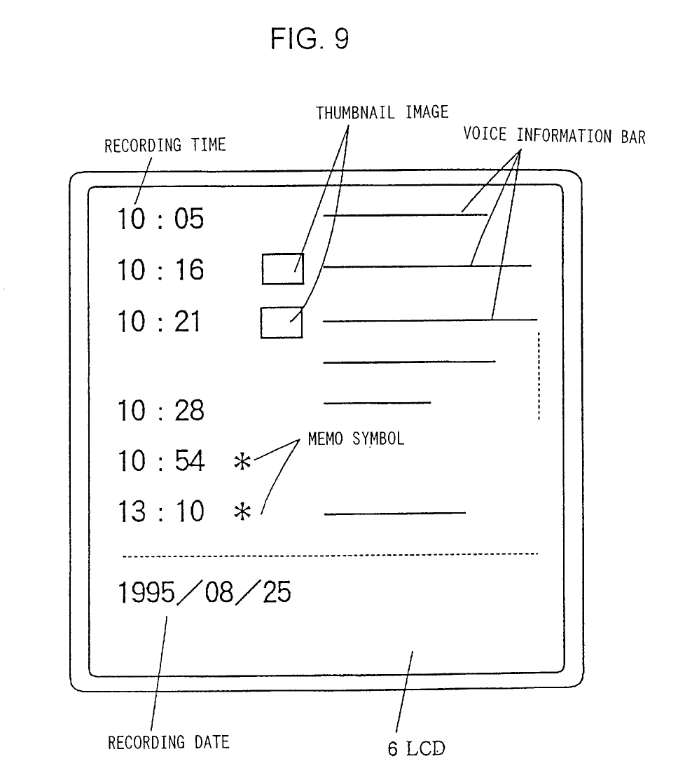

As described above, when line drawing information is entered with the pen while the photographic image is displayed on the LCD 6, the photographic image data and the line drawing information thus entered are combined together in the frame memory region of the buffer memory 36, and the combined image of the photographic image and line drawing is displayed on the LCD 6. In the memory card 24, on the other hand, the photographic image data is recorded in the photographic image recording region, and the line drawing information is recorded in the line drawing information recording region. With the two sets of information recorded in different regions of the memory card 24 in this manner, the user may delete one (line drawing, for example) of the photographic image and line drawing, from the combined image. This also makes it possible to compress respective sets of image information in different compression methods.

Where data are recorded in the voice recording region, photographic image recording region, or line drawing information recording region of the memory card 24, a certain display is provided on the LCD 6, as shown in FIG. 9.

On the display screen of the LCD 6 as shown in FIG. 9, the date (recording date) of the point of time when the information is recorded (in this case, Aug. 25, 1995) is displayed in the lower end portion of the screen, and the recording time when each set of information is recorded on this recording date is displayed in the leftmost portion of the screen.

A thumbnail image may be displayed to the right of the recording time. The thumbnail image is prepared by thinning out (reducing) bit map data of each of the photographic image data recorded in the memory card 24. The information displayed with the thumbnail image includes photographing image information. Namely, the information recorded (entered) at “10:16” and “10:21” contains photographic image information, and the information recorded at “10:05”, “10:28”, “10:54” and “13:10” does not contain photographic image information.

In FIG. 9, memo symbol “*” indicates that a certain memo is recorded as line drawing information.

Voice information bars are displayed to the right of the display region in which the thumbnail images are displayed, such that the length of each bar (line) represents the length of voice-recording time (no voice information bar is displayed where no voice information is entered).

The user selects and points to information to be reproduced, by pressing with the tip of the pen 41 a selected portion of one of display lines containing desired information on the LCD 6 as shown in FIG. 9, and then presses the execution key 7B shown in FIG. 2 with the tip of the pen 41 so as to reproduce the selected information.

For instance, if the line on which “10:05” is displayed as shown in FIG. 9 is pressed by the pen 41, the CPU 39 retrieves voice data corresponding to the selected voice-recording time (10:05) from the memory card 24, expands the voice data, and transmits the expanded data to the voice processing circuit 44. The voice processing circuit 44 converts the transmitted voice data to analog signals, which are then reproduced by means of the speaker 5.

Where photographic image data stored in the memory card 24 are to be reproduced, the user presses a desired thumbnail image with the tip of the pen 41 thereby to select its information, and reproduces the selected information by pressing the execution key 7B.

The CPU 39 gives a command to the compression and expansion circuit and memory controller 35 so as to retrieve photographic image data corresponding to the selected date and time of photographing from the memory card 24. The compression and expansion circuit and memory controller 35 then expands the photographic image data (compressed photographic image data) retrieved from the memory card 24, and the expanded photographic image data are stored as bit map data in the frame memory region of the buffer memory 36 and displayed on the LCD 6.

The image photographed in the “S” mode is displayed as a still image on the LCD 6. Needless to say, this still image is obtained by reproducing image signals of all of the pixels of the CCD 20.

The image photographed in the “L” mode is continuously displayed on the LCD 6 at the rate of 8 frames per second. In this case, the number of pixels displayed in each frame is one-quarter that of all pixels of the CCD 20.

Since human eyes are generally very sensitive to deterioration of the resolution of still images, the user may consider that the image quality is deteriorated if some pixels are taken out or eliminated from a still image. If the continuous shooting speed is increased upon photographing, and pictures are taken at the rate of 8 frames per second in the “L” mode, so that the image is reproduced at the rate of 8 frames per second, the number of pixels of each frame is reduced to one-quarter of that of all pixels of the CCD 20, but the user observes 8 frames of images in one second, whereby the amount of information received by the user's eyes in one second will be twice as much as that in the case of the still image.

More specifically, if the number of pixels in one frame of image photographed in the “S” mode is represented as 1, the number of pixels of the image photographed in the “L” mode will be ¼. When the image (still image) photographed in the “S” mode is displayed in the LCD 6, the amount of information that is received by human eyes in one second is represented as 1 (=(number of pixels 1)×(number of frames 8)). Where the image photographed in the “L” mode is displayed on the LCD 6, the amount of information received by human eyes in one second is represented as 2 (=(number of pixels ¼)×(number of frames 8)). (Namely, the information that is twice as much as that of the still image is observed by human eyes.) Thus, even if the number of pixels in one frame is reduced to one-quarter, the user can observe the reproduced image without worrying much about deterioration of the image quality.

Further, in the first embodiment, different pixels are sampled out for each frame, and the pixels thus sampled out are displayed on the LCD 6, thereby producing afterimage effects in human eyes. Thus, even if three-quarters of pixels are eliminated or taken out in each frame, the user still can observe the image photographed in the “L” mode and displayed on the LCD 6, without worrying much about deterioration of the image quality.

An image photographed in the “H” mode is continuously displayed on the LCD 6 at the rate of 30 frames per second. Although the number of pixels displayed in each frame is one-ninth of that of all pixels of the CCD 20, the user can observe the image photographed in the “H” mode and displayed on the LCD 6, without worrying much about deterioration of the image quality, for the same reason as in the case of the “L” mode.

In the first embodiment, when a subject is photographed in the “L” mode or “H” mode, the CDS 31 thins out the pixels of the CCD 20 to such an extent that the user does not have to worry about deterioration of the image quality upon reproduction of the image. This makes it possible to reduce burdens on the DSP 33 and the compression and expansion circuit and memory controller 35, and actuate the DSP 33 and compression and expansion circuit and memory controller 35 at a reduced speed with reduced electric power. Consequently, the cost and power consumption of the apparatus can be reduced.

In the first embodiment as described above, each type of information (data) recorded in the memory card 24 is accompanied by data relating to the date and time when the relevant information is entered, as header information. Thus, the user may select desired information based on the data of the date and time displayed on the LCD 6, and reproduce the selected information (FIG. 9).

Where plural types of information (photographic image, voice, line drawing) are concurrently entered, these types of information are separately recorded in the respective predetermined regions of the memory card 24, such that each type of information is accompanied by header information representing the same date and time.

In the case where information A (photographic image), information B (voice) and information C (line drawing) are concurrently entered, for example, each information A, B, C recorded in the corresponding region of the memory 24 is provided with data of the same date and time of input as header information. In another example, the header information attached to the information A may consist of data representing the date and time of input of this information A, and the header information attached to the information B and C may consist of data that indicate that the information B and C are related to or associated with the information A.

In the above arrangements, the plural types of information that are concurrently entered can be reproduced at the same time.

In the first embodiment, after the first information (for example, photographic image) is recorded, the second information (for example, line drawing) that Is different from the first information may be recorded as being added to the first information. Where the second information is added to the first information in this manner, the second information is entered while the first information is being reproduced. This particular case will be described below in detail.

For example, if the release switch 10 is pressed to execute processing for taking a picture of a subject while voice information that was previously recorded is being reproduced, photographic image data recorded in the photographic image recording region of the memory card 24 is accompanied by header information of the date and time when recording of the voice information was started.

Suppose the processing for taking a picture is executed during reproduction of voice information that started being recorded at 10:05 on Aug. 25, 1995, for example, after one minute elapses from the start of the reproduction (namely, when the date and time of the reproduced data is 10:06, Aug. 25, 1995). In this case, the photographic image data recorded in the photographic image recording region of the memory card 24 may be accompanied by header information indicative of 10:06, Aug. 25, 1996 or may be accompanied by header information representing the time of the start of voice-recording, i.e., 10:05. Any one of these modes may be registered as a default. (This selection may be made by the user.)

Similarly, if line drawing information is entered while voice information that was previously recorded is being reproduced, the line information is recorded in the line information recording region of the memory card 24, along with the same head information as that representing the date and time of recording of the voice information.

If line drawing information is entered while voice information and photographic image information that were concurrently entered are being reproduced, the line drawing information is recorded in the line drawing information recording region of the memory card 24, along with the same header information as that representing the date and time of recording of the voice information (or photographic image information).

If photographic image information is entered while voice information and line drawing information that were concurrently entered are being reproduced, the photographic image data are recorded in the photographic image recording region of the memory card 24, along with the same header information as that representing the date and time of recording of voice information (or line drawing information).

If voice information is entered while a photographic image that was previously entered is being reproduced, the voice data are recorded in the voice information recording region of the memory card 24, along with the same header information as that representing the date and time of recording of the photographic image.

If line drawing information is entered while a photographic image that was previously entered is being reproduced, the line drawing information is recorded in the line drawing information recording region of the memory card 24, along with the same header information as that representing the date and time of recording the photographic image.

If voice information is entered while photographic image information and line drawing information that were previously entered at the same time are being reproduced, the voice data are recorded in the voice recording region of the memory card 24, along with the same header information as that representing the date and time of recording of the photographic image information (or line drawing information).

If photographic image information is entered while the line information that was previously entered is being reproduced, the photographic image data are recorded in the photographic image recording region of the memory card 24, along with the same header information as that representing the date and time of recording of the line drawing information.

If voice information is entered while line drawing information that was previously entered is being reproduced, the voice data are recorded in the voice recording region of the memory card 24, along with the same header information as that representing the date and time of recording of the line drawing information.

As described above, if the second information is entered while the first information that was previously recorded is being reproduced, the header information for the second information represents the date and time of recording of the first information (this mode will be called “normal mode”). In this manner, it is possible to add information later while keeping the relationship between the original information and the added information.

Further, in the first embodiment, where the second embodiment is added to the first information that was previously recorded, the input or recording time of the second information may be recorded as header information for the second information, and header information for the first information may be replaced by the header information for the second information (this mode will be called “recording time change mode”.) In this case, the electronic camera 1 is further provided with a recording-time mode selector switch (not shown), and the recording date and time may be changed (one of the normal mode and recording time change mode may be selected) by the user.

For example, when the user is supposed to take a picture of a particular subject at a particular time some other day, and preliminarily records comments on the relevant photographic image as line drawing information (namely, the line drawing information is the first information), the above recording-time mode selector switch is switched to the recording-time change mode, and a picture of the particular subject is taken (namely, the photographic image is the second information) while the recorded line drawing information is being reproduced. In this case, both of the line drawing information (first information) and the photographic image (second information) are accompanied by header information representing the date and time of input of the photographic image (second information).

It is also possible to prioritize input information, and attach appropriate header information of input time to each piece of information according to the order of priority.

For example, photographic images are given the highest priority, and voice information is given the second highest priority, while line drawing information is given the third highest priority. In this case, if voice information is entered while the line drawing information that was previously recorded is being reproduced, both of the line drawing information and voice information recorded in the memory card 24 will be accompanied by head information containing the input time of the voice information (since the priority order of the voice information is higher than that of the line drawing information). If a photographic image is further entered while the above voice information and line drawing information are being reproduced, the line drawing information, voice information and photographic image recorded in the memory card 24 will be accompanied by header information containing the input time of the photographic image (since the priority order of the photographic image is higher than that of the other information). This order of priority may be set by the user.

There will be next described the case where voice is recorded at the same that a picture of a subject is being taken.

First, the case where the continuous shooting mode selector switch 13 is placed in the “S” mode (single-shot mode) will be described. If the voice-recording switch 12 is initially pressed, voice information is entered, and corresponding voice data are recorded in the voice information recording region of the memory card 24, along with header information indicative of the date and time when the recording is started. If the release switch 10 is pressed (in the “S” mode) while the voice information is being entered, one frame or shot of the subject is photographed, and corresponding photographic image data are recorded in the memory card 24. The photographic image data thus recorded is accompanied by header information indicative of the date and time when the release switch 10 is pressed (the time of the start of photographing).

If the release button 10 is initially pressed, on the other hand, one frame of the subject is photographed. In this case, the photographic image data recorded in the memory card 24 are accompanied by header information indicative of the date and time when the subject is photographed. If the release button 10 is kept being pressed, the photographed image is displayed on the LCD 6. If the voice-recording switch 12 is pressed at this time, voice information is entered. In this case, the voice data recorded in the voice information recording region of the memory card 24 are accompanied by header information indicating the date and time when the subject is photographed.

Next, the case where the continuous shooting mode selector switch 13 is placed in the “L” mode or “H” mode (continuous shooting mode) will be described. When the release switch 10 is first pressed, and the voice-recording switch 12 is then pressed, or when the release switch 10 and voice-recording switch 12 are pressed at the same time, the photographic image and voice information are recorded in the following manners.

In the case where the continuous shooting mode selector switch 13 is placed in the “L” mode, pictures are taken at the rate of 8 frames per second, and photographic image data for each frame recorded in the photographic image recording region of the memory card 24 is accompanied by header information indicating the date and time when the relevant picture is taken. Accordingly, the date and time is recorded at intervals of 0.125 seconds as the headers of the respective frames. At this time, the voice information is recorded every 0.125 seconds (though it is continuously entered), and the voice data recorded in the voice information recording region of the memory card 24 is accompanied by header information indicating the date and time of recording at the intervals of 0.125 seconds.

Similarly, in the case where the continuous shooting mode selector switch 13 is placed in the “H” mode, pictures are taken at the rate of 30 frames per second, and photographic image data for each frame recorded in the photographic image recording region of the memory card 24 is accompanied by header information indicating the date and time when the relevant picture is taken. Accordingly, the date and time is recorded at intervals of 1/30 seconds as the headers of the respective frames. At this time, the voice information is recorded every 1/30 seconds (though it is continuously entered), and the voice data recorded in the voice information recording region of the memory card 24 is accompanied by header information indicating the date and time of recording at the intervals of 1/30 seconds.

With the photographic image and voice information recorded in the above manner, if a certain photographic image is removed when photographic images and voice are edited after recording, the voice information having the same header information as that of the certain photographic image can be also removed.

If the voice-recording switch 12 is first pressed and the release switch 10 is then pressed, while the continuous shooting mode selector switch 13 is placed in the “L” mode or “H” mode (when the switch 13 is placed in a continuous shooting mode), the information recorded in the memory card 24 is accompanied by header information as described below.

In this case, voice data entered until the release switch 10 is pressed is recorded as one file in the voice information recording region of the memory card 24. If the release switch 10 is then pressed, the header information indicating the date and time of recording of each frame of photographic image is recorded along with the voice data.

As described above, image, voice and line drawing information and others are recorded in the above electronic camera 1. When the photographer 101 observes a subject through the finder 2, this electronic camera 1 stops displaying an image on the LCD 6, and also stops processing of information entered through the touch tablet 6A. Thus, the present camera 1 is able to prevent waste of electric power, and avoid wrong operations on the touch tablet 6A.

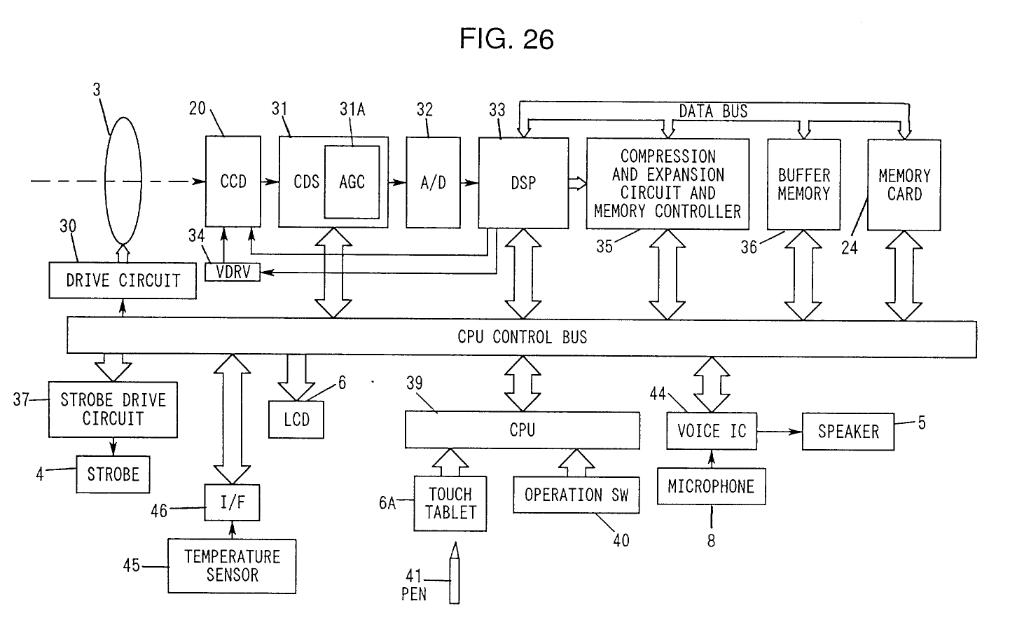

While the light-receiving element 43 is used to determine whether the photographer 101 has approached the finder 2 in the above-described first embodiment, the light-receiving element may be replaced by a temperature sensor 45, which is adapted to detect temperature changes as the photographer 101 approaches the finder 2. This modified arrangement is shown in FIG. 26. The electric arrangement of FIG. 26 is identical with that of FIG. 6 except the temperature sensor 45 and its interface 46.

Second Embodiment

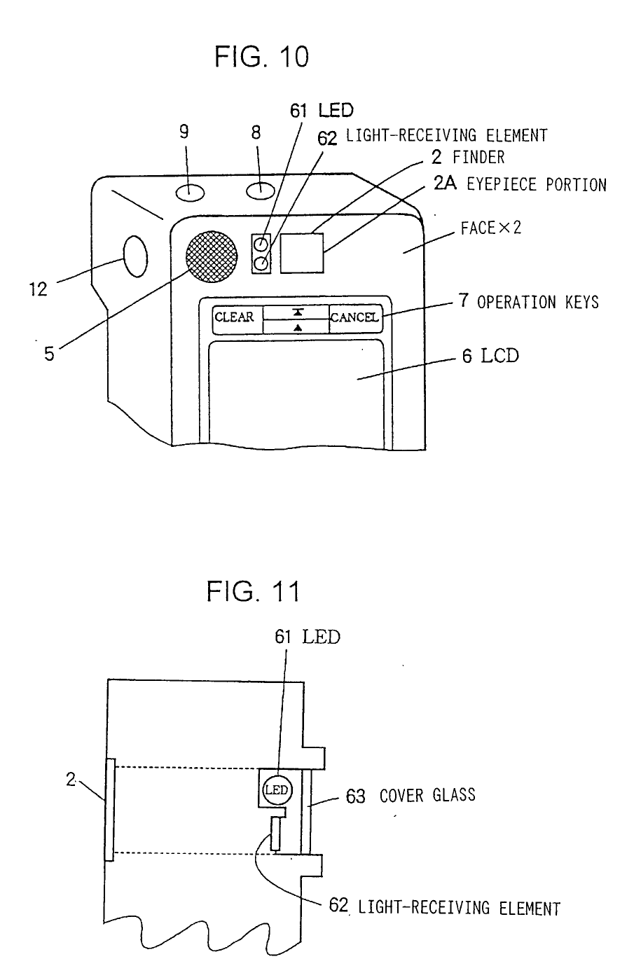

FIG. 10 shows the second embodiment of the present invention. The electronic camera 1 of the second embodiment is provided with an LED 61 (illuminating portion) and a light-receiving element 62 (detecting portion), which are disposed adjacent to the eyepiece portion 2A of the finder 2.

FIG. 11 shows one example of the locations of the LED 61 and light-receiving element 62. The LED 61 and light-receiving element 62 are located in a recessed portion formed in the face X2. A transparent cover glass 63 is provided at an open end of the recessed portion, for protecting the LED 61 and light-receiving element 62 against dust and the like. The other constituent elements of the second embodiment are substantially identical with those of the first embodiment as shown in FIGS. 1 and 2, and thus will not be explained herein.

The LED 61 thus located is adapted to emit a certain light beam through the cover glass 63.

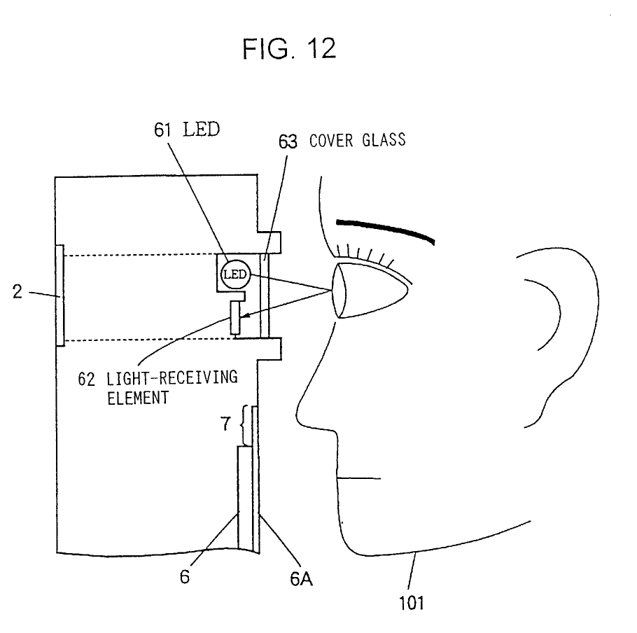

As shown in FIG. 12, the light-receiving element 62 is adapted to receive, through the cover glass 63, the light beam that is emitted by the LED 61 and reflected by an eye of the photographer 101, for example, and transmit an electric signal corresponding to the quantity of the received light to the CPU 39.

In this case, the LED 61 emits light that is distinguishable from natural light so that the emitted light is received by the light-receiving element 62. As the photographer 101 approaches the finder 2, the light emitted by the LED 61 is received by the light-receiving element 62, and the CPU 39 determines that the photographer 101 is approaching the finder 2, based on a change in the electric signal from the light-receiving element 62.

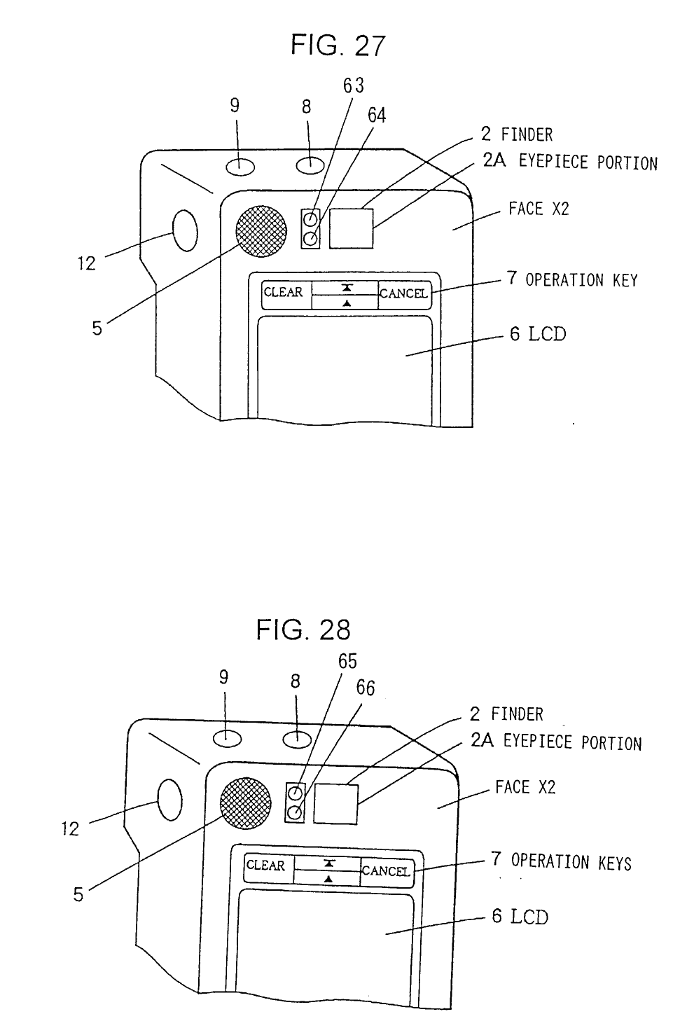

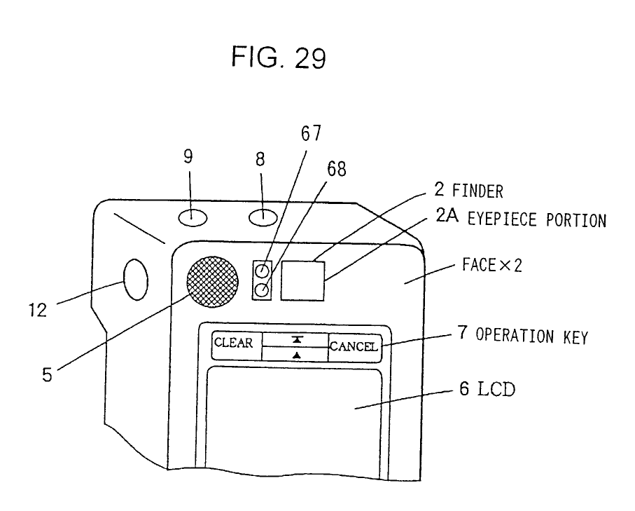

While the LED 61 is used in the second embodiment of FIG. 10 for emitting a certain light beam which is reflected and received (detected) by the light-receiving element 62, an infrared diode 63 (FIG. 27) or a laser diode 65 (FIG. 28) may be used in place of the LED 61, such that an infrared radiation or a laser radiation that is reflected by a photographer is received by a light-receiving element 64 (FIG. 27) or a light-receiving element 66 (FIG. 28), respectively. Also, an ultrasonic wave generating device 67 (FIG. 29) may be used in place of the LED 61, and an ultrasonic sensor 68 (FIG. 29) may be used in place of the light-receiving element 62, so as to measure a distance from the sensor 68 to the photographer, based on the time of propagation of ultrasonic wave (a period from the time when the ultrasonic wave is emitted until the time when the ultrasonic wave is reflected and detected by the ultrasonic sensor). Namely, any type of device may be used provided it is able to detect that the face of the photographer who is going to look through the finder 2 is approaching the finder 2.

Third Embodiment

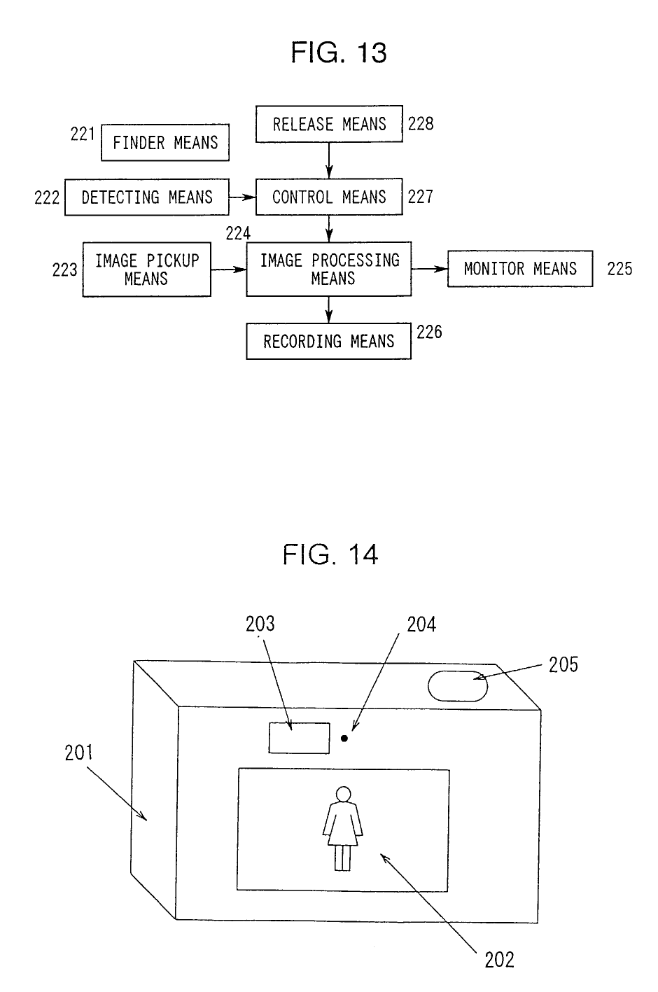

FIG. 13 is a view explaining the schematic construction of an image pickup apparatus according to the third embodiment of the present invention. As shown in FIG. 13, the image pickup apparatus of the third embodiment of the present invention comprises finder means 221 for confirming an image of a subject, detecting means 222 for detecting that the user has approached the finder means 221, image pickup means 223, such as CCD, for capturing the image of the subject so as to produce an image signal representing the subject, image processing means 224 for processing the image signal obtained by the image pickup means 223 according to a predetermined image processing program, monitor means 225 for displaying the image signal that has been processed by the image processing means 224, recording means 226 for recording the image signal that has been processed, control means 227 for controlling operations of the image processing means 224 and monitor means 225 based on a result of detection of the detecting means 222, and release means 228 for executing a release operation.

FIG. 14 is a perspective view showing the construction of a digital still camera as one example of the image pickup apparatus according to the third embodiment of the present invention. As shown in FIG. 14, the camera of the third embodiment includes a main body 201, monitor panel 202 on which a photographed image is displayed, a finder 203 through which the user confirms an image of a subject upon photographing, a sensor 4 for detecting that the user has approached the finder 203 so as to look through the finder 203, and a release button 205 for executing release operations. More specifically, the sensor 4 may employ a photo-reflector that determines whether the user has approaches the finder 203 depending upon the presence of reflected light, or a pyroelectric infrared sensor that makes the determination by measuring the intensity of infrared rays.

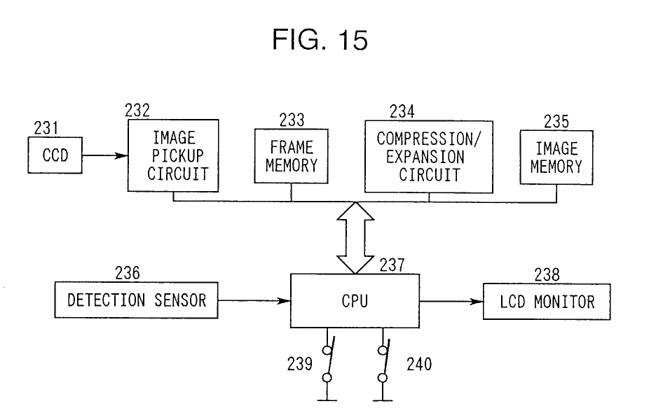

FIG. 15 is a block diagram showing the system structure of the camera shown in FIG. 14. As shown in FIG. 15, the system of the camera according to the present embodiment comprises a CCD unit 231 for capturing an image of a subject and photoelectrically converting the image into an image signal, image pickup circuit 232 for processing the image signal transmitted from the CCD 231, frame memory 233 for temporarily recording the image signal that has been processed in the image pickup circuit 232, compression/expansion circuit 234 for compressing or expanding the image signal, image memory 235 for recording the compressed image signal, detection sensor 236 for detecting that the user has approached the finder, CPU 237 for controlling the system, LCD monitor 238 for displaying the image signal as a visible image, power supply switch 239, and a release switch 40. The detection sensor 236 shown in FIG. 15 is identical with the sensor 4 shown in FIG. 14.

The operations of the third embodiment will be now explained.

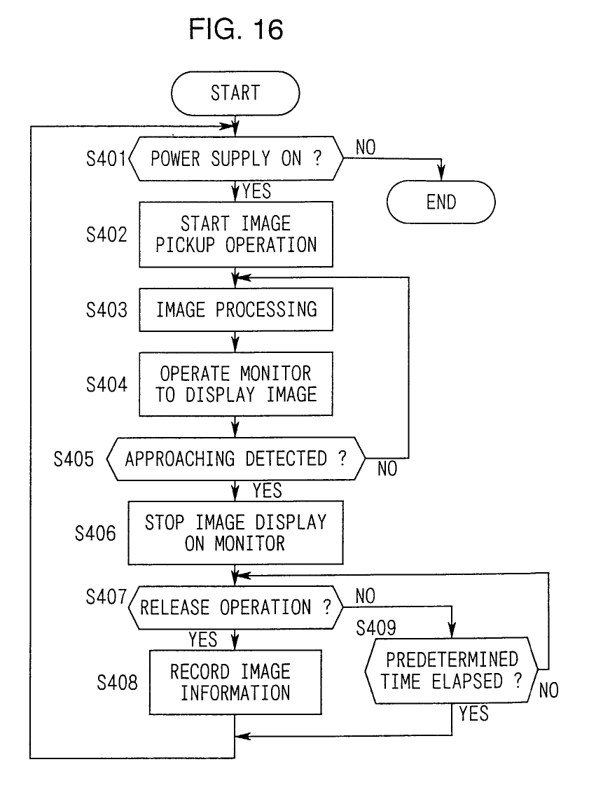

FIG. 16 is a flow chart explaining the operations of the third embodiment. Step S401 is initially executed to determine whether the power supply switch 239 of the apparatus is ON or not. If an affirmative decision is obtained in step S401, step S402 is executed to start an image pickup operation. In step S403, the image signal obtained by the CCD 231 is subjected to image processing in the image pickup circuit 232, and, in step S404, the operation of the monitor 238 is started so that the image is displayed by the image signal in real time on the monitor 238. Step S405 is then executed to check if the detection sensor 236 determines that the user has approached the finder so as to confirm the subject image through the finder. If a negative decision is obtained in step S405, the control flow returns to step S403, to repeat execution of steps S403-S405. If an affirmative decision is obtained in step S405, namely, if this step determines that the user is looking through the finder, step S406 is executed to stop the operation of the monitor 238. Namely, where the user is 3looking through the finder, the image displayed on the monitor 238 need not be observed, and therefore the operation of the monitor 238 is stopped. Step S407 is then executed to determine whether the release button has been operated to turn on the release switch 40, so as to execute a release operation. If an affirmative decision is obtained in step S407, step S408 is executed so that the image signal produced by the CCD 231 and subjected to image processing is recorded in the image memory 235, and the control flow returns to step S401. If a negative decision is obtained in step S407, step S409 is executed to determine whether a predetermined time has elapsed, and, if the predetermined time has elapsed, the control flow goes back to step S401.

In the third embodiment, the operation of the monitor 238 is stopped if it is determined that the user is looking through the finder so as to confirm the image of the subject. Thus, the power consumed by operating the monitor 238 can be reduced, and the battery is thus prevented from being rapidly consumed. Further, since the user has no chance of observing an image displayed on the monitor 238 while he/she is looking through the finder, any inconvenience will not arise during use.

Fourth Embodiment

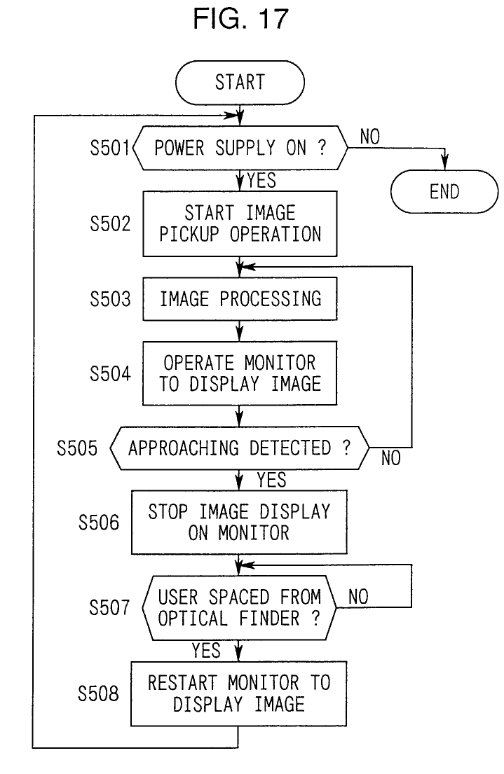

The fourth embodiment of the present invention will be now explained. FIG. 17 is a flow chart explaining operations of the fourth embodiment. Initially, step S501 is executed to determine whether the power supply switch 239 of the apparatus is ON or not. If an affirmative decision is obtained in step S501, step S502 is executed to start an image pickup operation. In step S503, the image signal produced by the CCD 231 is subjected to image processing in the image pickup circuit 232, and, in step S504, the operation of the monitor 238 is started so that the image is displayed by the image signal in real time on the monitor 238. Step S505 is then executed to check if the detection sensor 236 determines that the user has approached the finder so as to confirm the subject image through the finder. If a negative decision is obtained in step S505, the control flow returns to step S503, to repeat execution of steps S503-S505. If an affirmative decision is obtained in step S505, namely, if this step determines that the user is looking through the finder, step S506 is executed to stop the operation of the monitor 238. Namely, where the user is looking through the finder, the image displayed on the monitor 238 need not be observed nor confirmed, and therefore the operation of the monitor 238 is stopped. Step S507 is then executed to determine whether the user has been spaced apart from the finder, and the detection sensor 236 does not detect the user approaching the finder any longer. If an affirmative decision is obtained in step S507, the operation of the monitor 238 is restarted, and the control flow returns to step S501.

In the fourth embodiment, the operation of the monitor 238 is stopped if it is determined that the user is looking through the finder so as to confirm the image of the subject, as in the third embodiment. Thus, the electric power consumed by operating the monitor 238 can be reduced, and the battery is thus prevented from being rapidly consumed. Further, the operation of the monitor 238 is restarted or resumed when the user is spaced apart from the finder, which enables the user to immediately observe the image displayed on the monitor. Moreover, since the user has no chance of observing an image displayed on the monitor 238 while he/she is looking through the finder, any inconvenience will not occur during use.

Fifth Embodiment

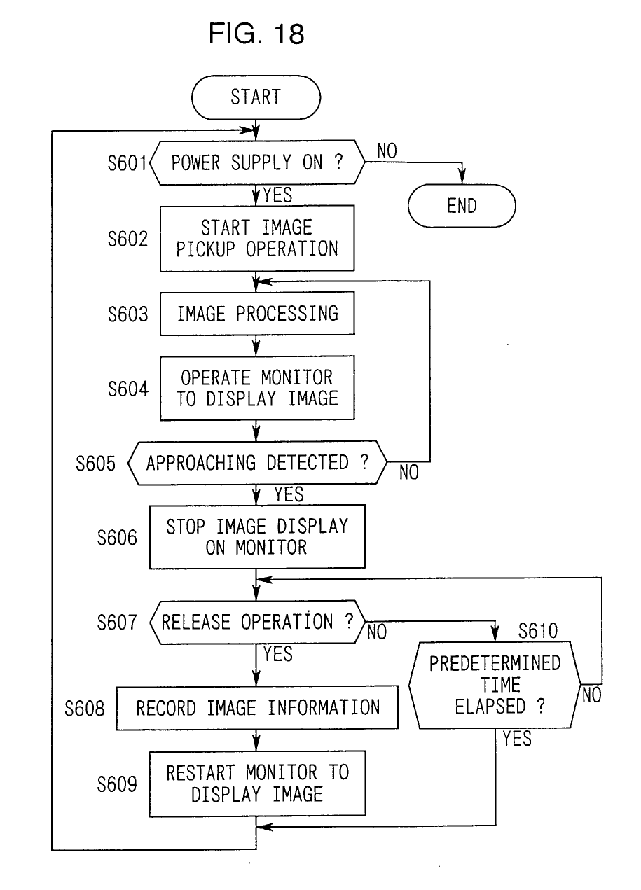

The fifth embodiment of the present invention will be now explained. FIG. 18 is a flow chart explaining operations of the fifth embodiment. Initially, step S601 is executed to determine whether the power supply switch 239 of the apparatus is ON or not. If an affirmative decision is obtained in step S601, step S602 is executed to start an image pickup operation. In step S603, the image signal produced by the CCD 231 is subjected to image processing in the image pickup circuit 232, and, in step S604, the operation of the monitor 238 is started so that the image is displayed by the image signal in real time on the monitor 238. Step S605 is then executed to check if the detection sensor 236 determines that the user has approached the finder so as to confirm the subject image through the finder. If a negative decision is obtained in step S605, the control flow returns to step S603, to repeat execution of steps S603-S605. If an affirmative decision is obtained in step S605, namely, if this step determines that the user is looking through the finder, step S606 is executed to stop the operation of the monitor 238. Namely, while the user is looking through the finder, the image displayed on the monitor 238 need not be observed, and therefore the operation of the monitor 238 is stopped. Step S607 is then executed to determine whether the release button has been operated to turn on the release switch 40 so as to execute a release operation. If an affirmative decision is obtained in step S607, step S608 is executed so that the image signal produced by the CCD 231 and subjected to image processing is recorded in the image memory 235. Step S609 is then executed to restart the operation of the monitor 238, and the control flow returns to step S601. If a negative decision is obtained in step S607, step S610 is executed to determine whether a predetermined time has elapsed, and, if the predetermined time has elapsed, the control flow goes back to step S601.

In the fifth embodiment, the operation of the monitor 238 is stopped if it is determined that the user is looking through the finder so as to observe the image of the subject. Thus, the power consumed by operating the monitor 238 can be reduced, and the battery is thus prevented from being rapidly consumed. Further, the operation of the monitor 239 is restarted or resumed after the release operation is performed to record the image, thus enabling the user to immediately observe the image displayed on the monitor 238. Moreover, since the user has no chance of observing an image displayed on the monitor 238 while he/she is looking through the finder, any inconvenience will not occur during use.

Sixth Embodiment

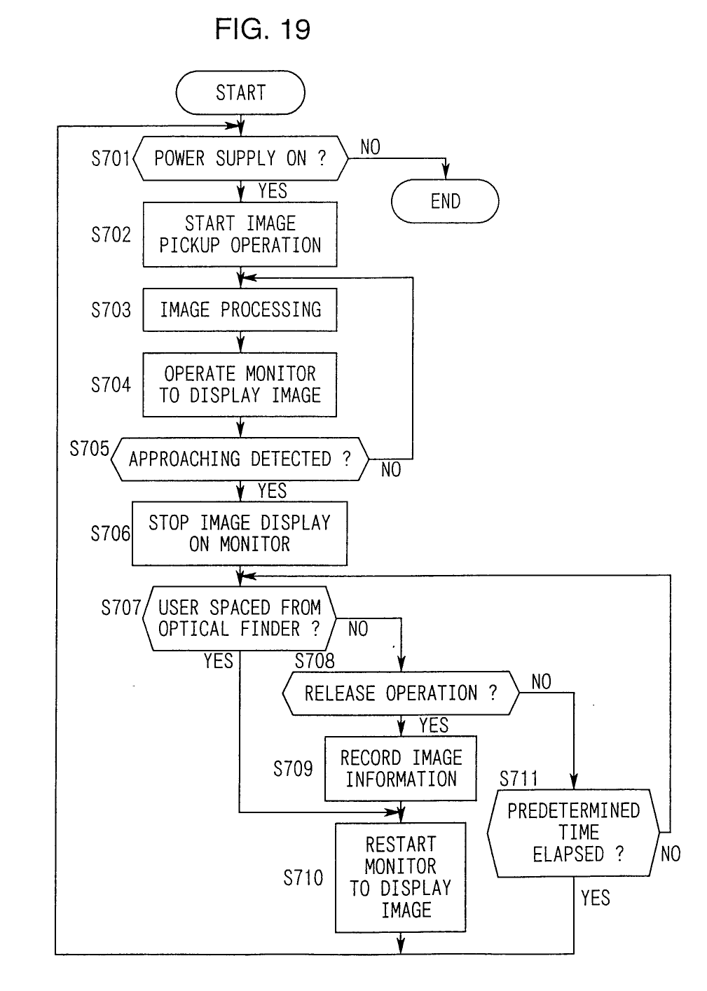

The sixth embodiment of the present invention will be now explained. FIG. 19 is a flow chart explaining operations of the sixth embodiment. Initially, step S701 is executed to determine whether the power supply switch 239 of the apparatus is ON or not. If an affirmative decision is obtained in step S701, step S702 is executed to start an image pickup operation. In step S703, the image signal produced by the CCD 231 is subjected to image processing in the image pickup circuit 232, and, in step S704, the operation of the monitor 238 is started so that the image is displayed by the image signal in real time on the monitor 238. Step S705 is then executed to check if the detection sensor 236 determines that the user has approached the finder so as to confirm the subject image through the finder. If a negative decision is obtained in step S705, the control flow returns to step S703, to repeat execution of steps S703-S705. If an affirmative decision is obtained in step S705, namely, if this step determines that the user is looking through the finder, step S706 is executed to stop the operation of the monitor 238. Namely, while the user is looking through the finder, the image displayed on the monitor 238 need not be observed, and therefore the operation of the monitor 238 is stopped. Step S707 is then executed to determine whether the user has been spaced apart from the finder, and the detection sensor 236 does not detect the user approaching the finder any longer.

If a negative decision is obtained in step S707, step S708 is then executed to determine whether the release button is operated to turn on the release switch 40 so as to execute a release operation. If an affirmative decision is obtained in step S708, step S709 is executed so that the image signal produced by the CCD 231 and subjected to image processing is recorded in the image memory 235. Step S710 is then executed to restart the operation of the monitor 238, and the control flow returns to step S701. If an affirmative decision is obtained in step S707, on the other hand, the control flow goes to step S710 to restart the operation of the monitor 238, and then returns to step S701. If a negative decision is obtained in step S708, step S711 is executed to determine whether a predetermined time has elapsed, and, if the predetermined time has elapsed, the control flow goes back to step S701.

In the sixth embodiment, the operation of the monitor 238 is stopped if it is determined that the user is looking through the finder so as to confirm the image of the subject. Thus, the power consumed by operating the monitor 238 can be reduced, and the battery is thus prevented from being rapidly consumed. Further, the operation of the monitor 239 is restarted or resumed in the case where the user is spaced or separated from the finder, and in the case where the image was recorded by conducting the release operation, thus enabling the user to immediately observe the image displayed on the monitor 238. Moreover, since the user has no chance of observing an image displayed on the monitor 238 while he/she is looking through the finder, any inconvenience will not occur during use.

Seventh Embodiment

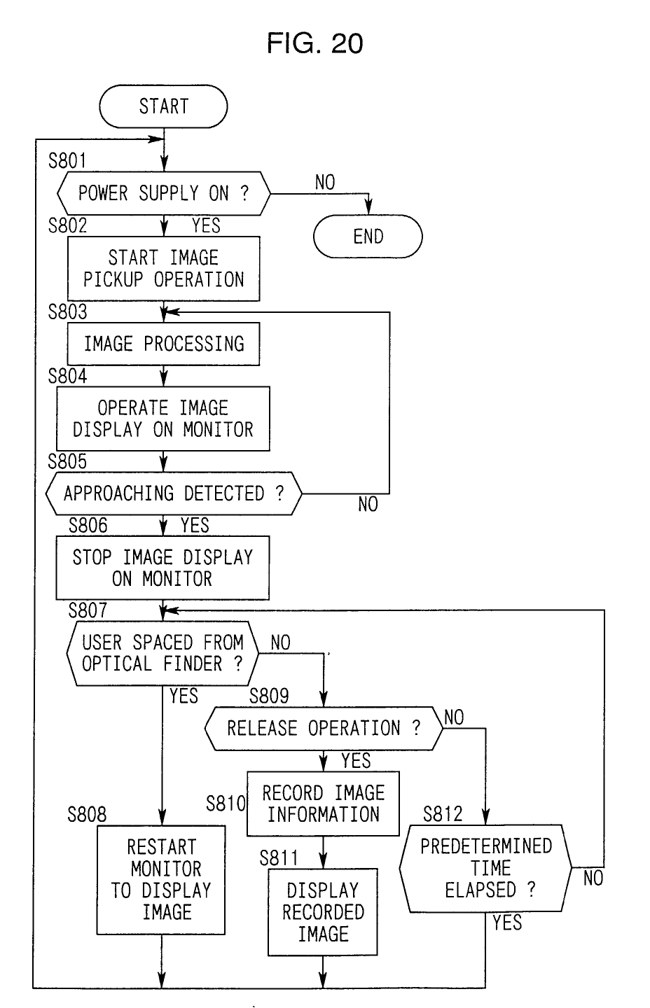

The seventh embodiment of the present invention will be now explained. FIG. 20 is a flow chart explaining operations of the seventh embodiment. Initially, step S801 is executed to determine whether the power supply switch 239 of the apparatus is ON or not. If an affirmative decision is obtained in step S801, step S802 is executed to start an image pickup operation. In step S803, the image signal produced by the CCD 231 is subjected to image processing in the image pickup circuit 232, and, in step S804, the operation of the monitor 238 is started so that the image is displayed by the image signal in real time on the monitor 238. Step S805 is then executed to check if the detection sensor 236 determines that the user has approached the finder so as to confirm the subject image through the finder. If a negative decision is obtained in step S805, the control flow returns to step S803, to repeat execution of steps S803-S805. If an affirmative decision is obtained in step S805, namely, if this step determines that the user is looking through the finder, step S806 is executed to stop the operation of the monitor 238. Namely, while the user is looking through the finder, the image displayed on the monitor 238 need not be observed, and therefore the operation of the monitor 238 is stopped. Step S807 is then executed to determine whether the user has been spaced apart from the finder, and the detection sensor 236 does not detect the user approaching the finder any longer. If an affirmative decision is obtained in step S807, step S808 is executed to restart the operation of the monitor 238, and the processing is terminated.

If a negative decision is obtained in step S807, on the other hand, step S809 is then executed to determine whether the release button is operated to turn on the release switch 40 so as to execute a release operation. If an affirmative decision is obtained in step S809, step S810 is executed so that the image signal produced by the CCD 231 and subjected to image processing is recorded in the image memory 235. Step S811 is then executed to display the recorded image on the monitor 238, and the control flow returns to step S801. If a negative decision is obtained in step S809, step S812 is executed to determine whether a predetermined time has elapsed, and, if the predetermined time has elapsed, the control flow goes back to step S801.

In the seventh embodiment, the operation of the monitor 238 is stopped if it is determined that the user is looking through the finder so as to confirm the subject image. Thus, the power consumed by operating the monitor 238 can be reduced, and the battery is thus prevented from being rapidly consumed. Further, the operation of the monitor 239 is restarted where the user has been spaced apart from the finder, thus enabling the user to immediately observe the image displayed on the monitor 238. Moreover, after the image is recorded by conducting the release operation, the recorded image is displayed on the monitor 238, thus enabling the user to immediately observe the photographed image. Furthermore, since the user has no chance of observing an image displayed on the monitor 238 while he/she is looking through the finder, any inconvenience will not arise during use.

Eighth Embodiment

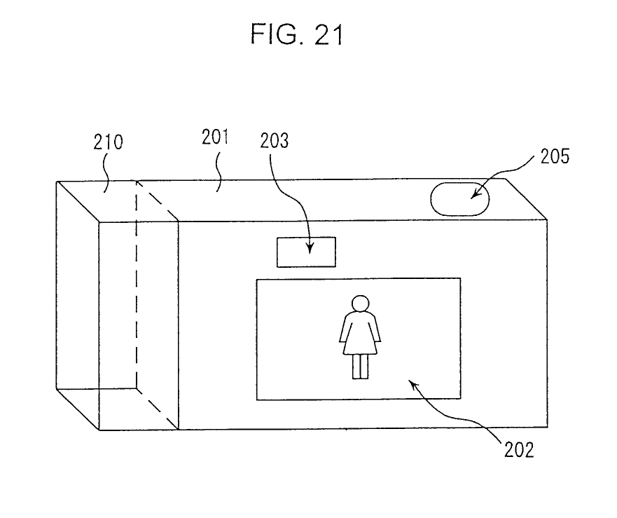

FIG. 21 is a perspective view showing the construction of a digital still camera as an example of an image pickup apparatus according to the eighth embodiment of the present invention. In FIG. 21, the same reference numerals as used in FIG. 14 are used to identify the same elements or members, and no detailed description of these elements will be provided. As shown in FIG. 21, the camera of the eighth embodiment is constructed such that its main body 201 and image pickup portion 210 are separable from each other.

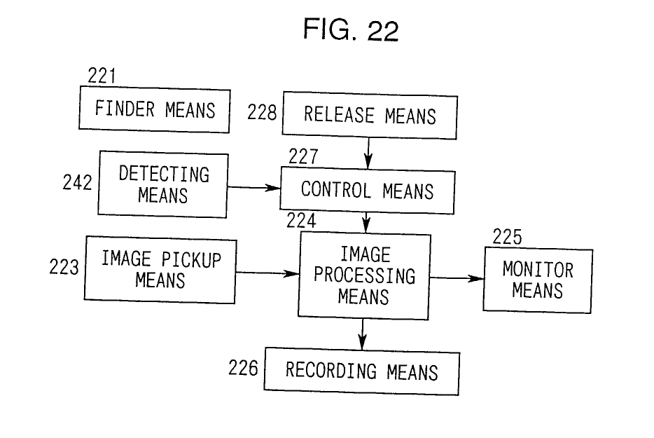

FIG. 22 is a view explaining the schematic construction of the image pickup apparatus according to the eighth embodiment of the present invention. In FIG. 22, the same reference numerals as used in FIG. 13 are used to identify the same elements or means, and no detailed description of these elements will be provided. As shown in FIG. 22, the image pickup apparatus according to the eighth embodiment of the present invention includes detecting means 242 for detecting that the image pickup portion 210 has been detached from the main body 201.

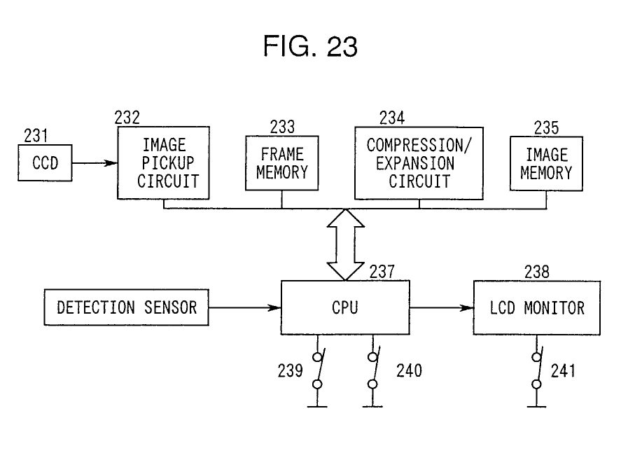

FIG. 23 is a block diagram showing the system structure of the camera according to the eighth embodiment. In FIG. 23, the same reference numerals as used in FIG. 15 are used to identity the same elements, and no detailed description of these elements will be provided. As shown in FIG. 23, the image pickup apparatus of the eighth embodiment includes a detection sensor 46 for detecting detachment of the image pickup portion 210 from the main body 201, and a monitor switch 41 for switching the ON/OFF state of the monitor 238.

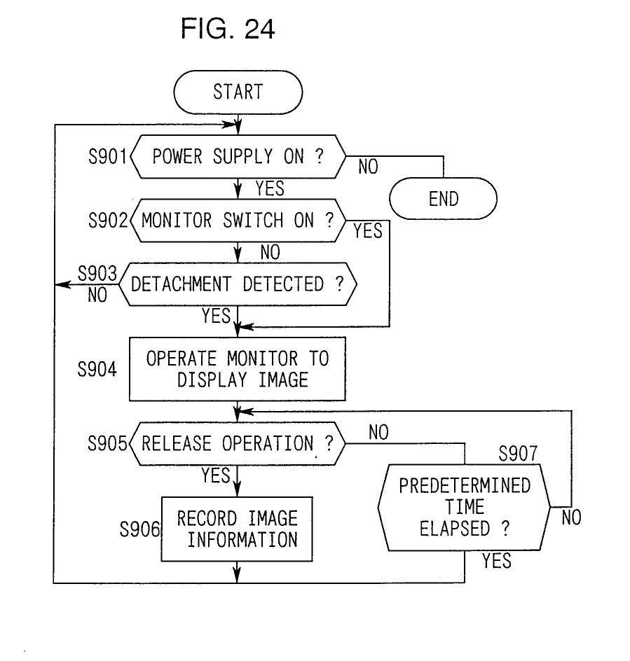

The operations of the eighth embodiment will be explained. FIG. 24 is a flow chart explaining the operations of the eighth embodiment. Initially, step S901 is executed to determine whether the power supply switch 239 of the apparatus is ON or not. If an affirmative decision is obtained in step S901, step S902 is executed to determine whether the monitor switch 41 is placed in the ON state or not. If the monitor switch 41 is OFF, the control flow goes to step S903 to check if the detection sensor 46 has detected removal or detachment of the image pickup portion 210. If a negative decision is obtained in step S903, the control flow returns to step S901. If an affirmative decision is obtained in step S903, step S904 is executed to start the operation of the monitor 238. If step S905 determines that the release button has been operated to turn on the release switch 40 so as to execute a release operation, step S906 is executed so that the image signal produced by the CCD 231 and subjected to image processing is recorded in the image memory 235, and the control flow goes back to step S901. If an affirmative decision is obtained in step S902, step S903 is skipped and step 904 is executed to start the operation of the monitor 238. When a negative decision is obtained in step S905, step S907 is executed to determine whether a predetermined time has elapsed, and, if the predetermined time has elapsed, the control flow goes back to step S901.

In the eighth embodiment, the operation of the monitor 238 is stopped until the image pickup portion 210 for capturing the image of the subject is detached from the main body 201, and the operation of the monitor 238 is started when the image pickup portion 210 is detached from the main body 201, and when the monitor switch 41 is turned ON. In this arrangement, the electric power consumed by operating the monitor 238 until photographing is started can be reduced, and the battery is thus prevented from being rapidly consumed.

Ninth Embodiment

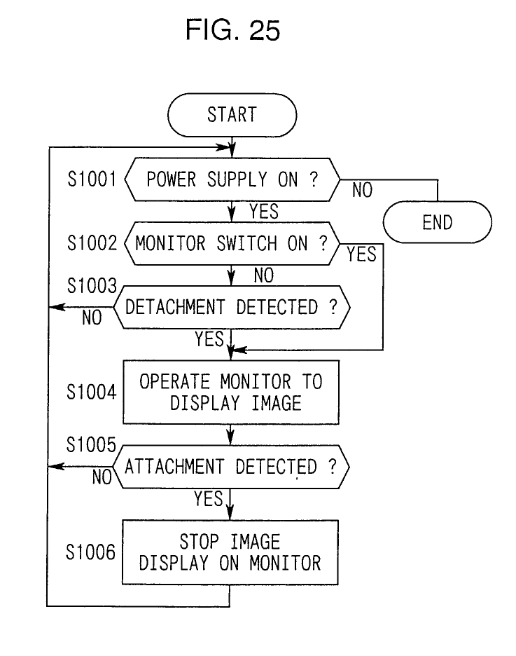

The operations of the ninth embodiment will be explained. FIG. 25 is a flow chart explaining the operations of the ninth embodiment. Initially, step S1001 is executed to determine whether the power supply switch 239 of the apparatus is ON or not. If an affirmative decision is obtained in step S1001, step S1002 is executed to determine whether the monitor switch 41 is placed in the ON state or not. If the monitor switch 41 is OFF, the control flow goes to step S1003 to check if the detection sensor 46 has detected detachment of the image pickup portion 210. If a negative decision is obtained in step S1003, the control flow returns to step S1001. If an affirmative decision is obtained in step S1003, step S1004 is executed to start the operation of the monitor 238. Step S1005 is then executed to determine whether the image pickup portion 210 is attached to the main body, and the detection sensor 46 does not detect the image pickup portion 210 detached from the main body any longer. If a negative decision is obtained in step S1005, the control flow returns to step S1001. If an affirmative decision is obtained in step S1005, step S1006 is executed to stop the operation of the monitor 238, and the control flow returns to step S1001.

Thus, in the ninth embodiment, the operation of the monitor 238 is stopped until the image pickup portion 210 is detached from the main body 201 to capture an image of a subject, and the operation of the monitor 238 is started when the image pickup portion 210 is detached from the main body 201, and when the monitor switch 41 is turned ON. Further, the operation of the monitor 238 is stopped again when the image pickup portion 210 is attached to the main body 201. It is thus possible to reduce the electric power consumed by operating the monitor 238 until photographing is started and after photographing is finished, thereby preventing the battery from being rapidly consumed.

While the finder 203 is provided in the main body 201 of the camera in the sixth and ninth embodiments, the finder 203 is not necessarily provided since the subject to be photographed can be observed or confirmed on the monitor 2.

What is claimed is:

1. An image pickup apparatus, comprising:
an image pickup device that captures an image of a subject so as to produce an image signal representing the subject; and
a main body having a display device on which a visible image is displayed by said image signal,
wherein said image pickup device is provided on said main body such that the image pickup device is detachable from the main body, said image pickup apparatus further comprising:
a detachment detecting device that detects detachment of said image pickup device from said main body; and
a control device that controls an operation of said display device, based on a result of detection of said detachment detecting device.

2. An image pickup apparatus according to claim 1, wherein said control device starts a display operation of said display device when said detachment detecting device detects detachment of said image pickup device.

3. An image pickup apparatus according to claim 1, wherein said control device starts a display operation of said display device when said detachment detecting device detects detachment of said image pickup device, and inhibits the display operation of the display device when said detachment detecting device detects attachment of said image pickup device to said main body.
